(19) United States
(12) Patent Application Publication
(10) Pub. No.: US 2005/0149248 A1
(43) Pub. Date: Jul. 7, 2005

(54) Location-sensitive engine emission control system and method

(76) Inventors: Jerry Van Polen, Oak Park, IL (US); Paul Gottemoller, Palos Park, IL (US)

Correspondence Address: CARY W. BROOKS;General Motors Corporation, Mail Code 482-C23-B21, P.O. Box 300, Detroit, MI, 48265-3000, US

(21) Appl. No.: 10/752,734

(22) Filed: Jan. 7, 2004

(51) Int. Cl. F02D 41/26; F02P 5/15

(52) U.S. Cl. 701/105; 701/115

(57) ABSTRACT

A location-sensitive engine control system includes position locating system (PLS) interfacing with control logic which in turn interfaces with an engine control. Location coordinates from the PLS are relayed to the control logic and compared to an emissions map to determine the emission requirements and corresponding engine control settings. The engine control receives the engine control settings from the control logic and adjusts engine parameters to allow the engine to comply with the emission requirements. If desired, emissions information may be stored in the control logic. An antenna or other suitable device for receiving and transmitting information may interface with the control logic to provide emissions map updates and to allow transmission of the emissions information.

### TECHNICAL FIELD

This invention relates to engine emission controls and, more particularly, to a location-sensitive emission control system and method of operating an engine within emission standards.

### BACKGROUND OF THE INVENTION

In order to meet various emissions standards, engines may be tuned or adjusted to control exhaust gas emissions. Unfortunately, tuning an engine to reduce exhaust gas emissions may also reduce fuel economy and/or engine performance.

Due to the various emissions standards throughout the world, an engine meeting emissions standards for one locality may not meet emissions requirements for other localities. In addition, changes to emissions regulations may cause a compliant engine to become noncompliant after a change. In some circumstances, emissions may be taxed based upon use.

A method of determining emission control requirements at a certain time and location coupled with a system for altering engine emissions to meet the requirements is desired. In addition, a method of recording and relaying emissions information such as horse power, engine run time, and location is desired to determine tax liability based upon usage in a particular location.

### SUMMARY OF THE INVENTION

The present invention provides an engine emission control system and method which varies an engines emissions based upon geographic location and local emissions regulations. The emissions control system may further be used to record and transmit emissions information for use in determining emissions tax liability.

The emission control system includes a position locating system (PLS) interfacing with a control logic which in turn interfaces with an engine control. The PLS determines location coordinates and relays the coordinates to the control logic. The coordinates are then compared to an emission map within the control logic to determine the emission requirements at the given coordinates and corresponding engine control settings. The control settings are then relayed to the engine control which adjusts the engines control settings to meet the emissions requirements.

If desired, emissions information may be stored to create an emissions log for usage with emission taxation. An antenna may be used to transmit the emissions log to a government agency such as the Environmental Protection Agency (EPA) to record and determine emissions tax liability.

The emissions map contained within the control logic may be updated to reflect changes in emissions regulations. Preferably, the control logic is updated through a radio transmission received by the antenna interfacing with the control logic.

These and other features and advantages of the invention will be more fully understood from the following description of certain specific embodiments of the invention taken together with the accompanying drawings.

### BRIEF DESCRIPTION OF THE DRAWINGS

FIG. 1 is a diagram showing a location-sensitive emissions control system in accordance with the present invention; and

FIG. 2 is diagram illustrating the method of operation of the emissions control system of FIG. 1.

### DESCRIPTION OF THE PREFERRED EMBODIMENT

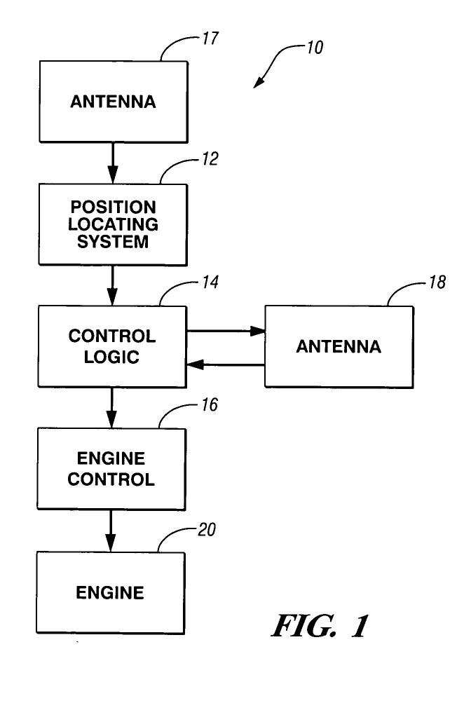

Referring now to FIG. 1 of the drawings in detail, numeral 10 generally indicates a location-sensitive emission control system. The system 10 includes a position locating system (PLS) 12 interfacing with control logic 14 which in turn interfaces with an engine control 16. The PLS may include a global positioning sub-system (GPS), a terrestrial positioning system, or a loran. The PLS 12 may have an internal or external antenna 17 for receiving satellite signals. A second antenna 18 or other suitable device for receiving and transmitting information interfaces with the control logic 14. The engine control 16 is connected to an engine 20 operative to control engine emissions. The engine 20 is mounted in a mobile unit or vehicle capable of operation in various geographical areas wherein exhaust emissions regulations may vary from place to place. Examples of such engine applications include automobiles, trucks, railway locomotives, mobile power units, construction machinery, watercraft, and so forth.

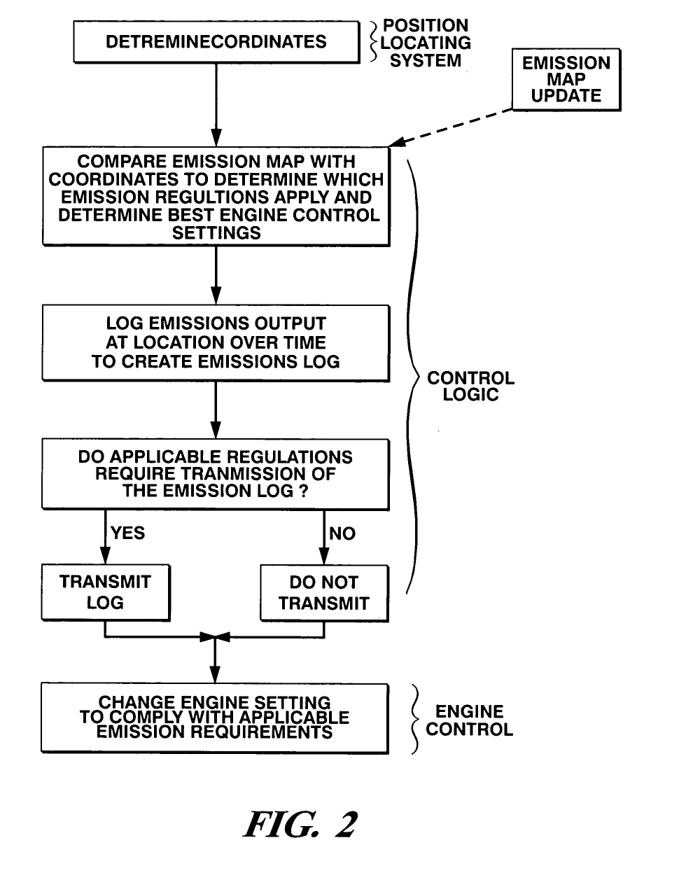

Referring now to FIGS. 1 and 2, the PLS 12 functions to determine the geographic location of the engine 20 by receiving signals from satellites or other suitable positioning sources and calculating location coordinates in a conventional manner. The coordinates are then relayed to the control logic 14 via a serial data stream or other suitable protocol.

The control logic 14 stores an emissions map which is compared to the incoming coordinates. The control logic 14 compares the coordinates to the map and determines the emissions requirements at the given coordinates. The emissions requirements are then converted to one or more specific engine control settings which are then relayed to the engine control 16. Preferably, the control logic 14 will chose the engine control settings, which give the best fuel economy or performance allowable under the applicable emission requirements.

The engine control system 16 adjusts the corresponding engine parameters to operate within the given emissions requirements. Emissions may be controlled by adjusting diesel fuel injection timing, ignition spark timing, varying valve timing or applying any other suitable method of emission control.

If desired information such as the time, location, and emissions output may be stored within the control logic 14 to create an emissions log. The emissions log may be locally stored within the control logic 14 for later use or transmitted through the antenna 18 or other means to a governmental agency, such as the EPA, to record and determine emissions tax liability.

The emissions map contained within the control logic 14 may be updated to reflect changes in emission regulations. Preferably, the control logic is updated through a radio transmission received by the antenna 18 interfacing with the control logic 14. However, updates to the control logic 14 may be obtained in other ways such as uploading through a local port or interface.

In operation, a vehicle equipped with the emissions control system 10 actively monitors emissions requirements and varies engine exhaust gas emissions accordingly. When the vehicle enters an area where emissions regulations are less stringent or not applicable, the emissions control system 10 adjusts engine operating parameters, within the emissions limits, for the maximum fuel efficiency or performance possible. When the vehicle enters an area where emissions regulations are more stringent, the emissions control system 10 further adjusts the engine operating parameters to comply with the regulations while maintaining maximum fuel efficiency and performance.

If an emission regulation changes over time, the change may be transmitted to the emissions control system 10 through antenna 18 to update the emissions map contained within the control logic 14. As the control logic 14 receives emissions map updates, the emissions control system 10 will respond by altering the engines operating parameters to operate at the maximum allowable fuel efficiency and performance under the limits of the new emissions map.

In areas where emissions are taxed based upon use, the emissions control system 10 will store and/or transmit the emissions log for determining tax liability. In addition, the emissions control system 10 may also adjust engine operating parameters to minimize emissions and thereby reduce tax liability.

While the invention has been described by reference to certain preferred embodiments, it should be understood that numerous changes could be made within the spirit and scope of the inventive concepts described. Accordingly, it is intended that the invention not be limited to the disclosed embodiments, but that it have the full scope permitted by the language of the following claims.

1. A location-sensitive engine control system for use with an internal combustion engine, the system comprising:
a position locating system interfacing with control logic that further interfaces with an engine control;
the position locating system determining location coordinates for the engine and relaying the coordinates to the control logic;
the control logic having an emissions map and comparing the coordinates to the map to determine corresponding emissions regulations which are converted to corresponding engine control settings that are relayed to the engine control; and
the engine control adjusts the engine control settings to alter the engine operating parameters to comply with the emissions regulations.

2. A system as in claim 1 wherein the control logic stores emissions data as an emissions log.

3. A system as in claim 2 including an antenna connected to the control logic for transmitting emissions log information.

4. A system as in claim 1 including an antenna connected to the control logic for receiving emissions map updates.

5. A method of controlling engine emissions comprising the steps of:
providing an engine emission control system including position locating system interfacing with control logic and the control logic that further interfaces with an engine control;
determining location coordinates with the position locating system and relaying the location coordinates to the control logic;
comparing the location coordinates to an emissions regulation map in the control logic to determine emission requirements, converting the requirements to engine control settings;
relaying the control settings to the engine control; and
varying the control settings with the engine control to comply with the emissions requirements.

6. A method as in claim 5 including recording emissions output over time and location to create an emissions log.

7. A method as in claim 6 including transmitting the emissions log information.

8. A method as in claim 7 wherein the emissions log information is transmitted to determine tax liability.

9. A method as in claim 5 including receiving control logic emissions map information to update the emissions map.

10. A method as in claim 5 including uploading control logic emissions map information to update the emissions map.

11. A method as in claim 5 wherein engine emissions are varied by altering engine fuel injection timing.

12. A method as in claim 5 wherein engine emissions are varied by altering spark ignition timing.

13. A method as in claim 5 wherein engine emissions are varied by altering valve timing.
